(19) United States
(12) Patent Application Publication
(10) Pub. No.: US 2016/0219236 A1
(43) Pub. Date: Jul. 28, 2016

(54) SOLID-STATE IMAGE PICKUP DEVICE

(71) Applicant: Kabushiki Kaisha Toshiba, Minato-ku (JP)

(72) Inventor: Motohiro MAEDA, Oita (JP)

(73) Assignee: Kabushiki Kaisha Toshiba, Minato-ku (JP)

(21) Appl. No.: 15/001,981

(22) Filed: Jan. 20, 2016

(30) Foreign Application Priority Data
Jan. 26, 2015 (JP) 2015-012535

(51) Int. Cl. H04N 5/378; H04N 5/225

(52) U.S. Cl. CPC H04N 5/378; H04N 5/2253

(57) ABSTRACT

A solid-state image pickup device according to an embodiment includes a photoelectric conversion element, a first floating diffusion, and a second floating diffusion. The photoelectric conversion element photoelectrically converts incident light into signal charge. The first floating diffusion retains the signal charge that is transferred from the photoelectric conversion element. The second floating diffusion is electrically connectable to or separable from the first floating diffusion and is capable of retaining the signal charge.

### CROSS-REFERENCE TO RELATED APPLICATIONS

This application is based upon and claims the benefit of priority from Japanese Patent Application No. 2015-012535, filed on Jan. 26, 2015; the entire contents of which are incorporated herein by reference.

### FIELD

Embodiments described herein relate generally to a solid-state image pickup device.

### BACKGROUND

Conventionally, a solid-state image pickup device includes a plurality of photoelectric conversion elements that photoelectrically convert incident light into signal charges, and a floating diffusion that temporarily retains the signal charges that are transferred from the photoelectric conversion elements.

An S/N ratio (Signal to Noise ratio) of such a solid-state image pickup device becomes better as the number of saturation electrons of the floating diffusion is reduced. However, in a case where saturation electrons of the floating diffusion are few and a bright image is picked up, the floating diffusion readily reaches a saturation state and it is difficult to determine tone of incident light with high brightness.

On the other hand, in a case where the number of saturation electrons of the floating diffusion of the solid-state image pickup device is large, the floating diffusion does not readily reach the saturation state even if a bright image is picked up. Hence, it is possible to determine tone of light with high brightness at good accuracy but the S/N ratio is degraded.

### BRIEF DESCRIPTION OF THE DRAWINGS

FIG. 1 is a block diagram illustrating a general configuration of a digital camera that includes a solid-state image pickup device according to an embodiment.

FIG. 2 is a block diagram illustrating a general configuration of a solid-state image pickup device according to the embodiment.

FIG. 3 is a diagram illustrating an example of a circuit configuration of a pixel array according to the embodiment.

FIG. 4 is a diagram illustrating a pixel cell according to the embodiment in a planar view.

FIG. 5 is a cross-sectional diagram illustrating a pixel cell according to the embodiment with respect to line A-A′ illustrated in FIG. 4.

FIG. 6 is a cross-sectional diagram illustrating a pixel cell according to the embodiment with respect to line B-B′ illustrated in FIG. 4.

FIG. 7 is a cross-sectional diagram illustrating a pixel cell according to variation example 1 of the embodiment.

FIG. 8 is a cross-sectional diagram illustrating a pixel cell according to variation example 2 of the embodiment.

### DETAILED DESCRIPTION

According to the present embodiment, a solid-state image pickup device is provided. A solid-state image pickup device according to one embodiment includes a photoelectric conversion element, a first floating diffusion, and a second floating diffusion. The photoelectric conversion element photoelectrically converts incident light into a signal charge. The first floating diffusion retains the signal charge that is transferred from the photoelectric conversion element. The second floating diffusion is electrically connectable to or separable from the first floating diffusion and is capable of retaining the signal charge.

Hereinafter, a solid-state image pickup device according to an embodiment will be described in detail, with reference to the accompanying drawings. The present invention is not limited to this embodiment.

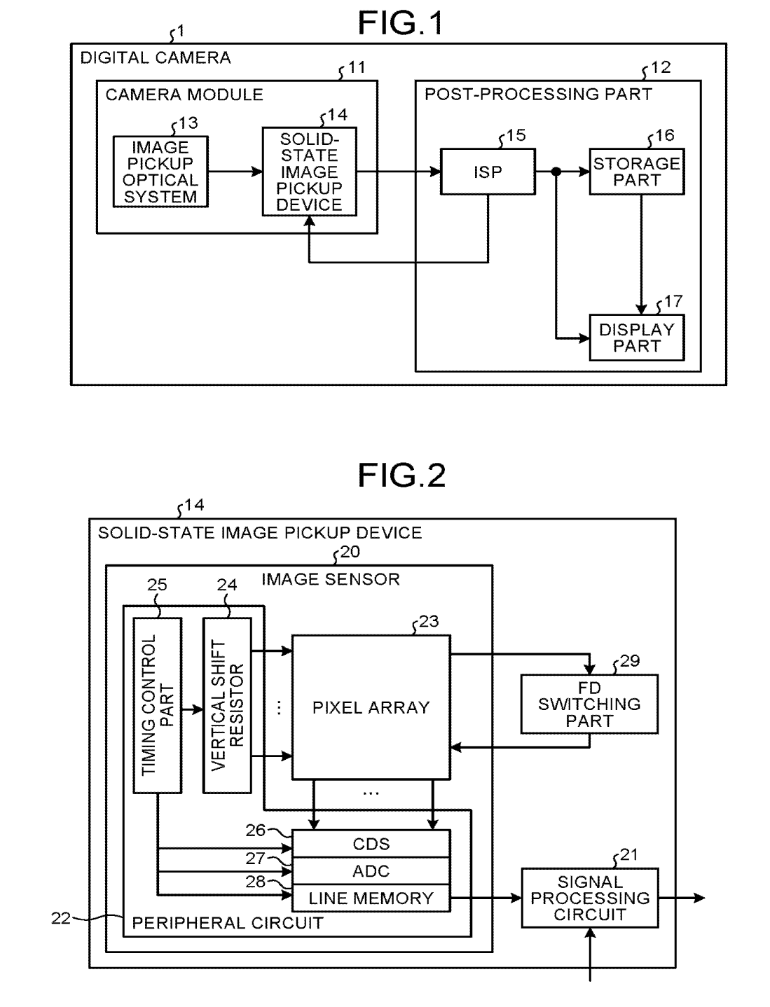

FIG. 1 is a block diagram illustrating a general configuration of a digital camera 1 that includes a solid-state image pickup device 14 according to the embodiment. As illustrated in FIG. 1, the digital camera 1 includes a camera module 11 and a post-processing part 12.

The camera module 11 includes an image pickup optical system 13 and a solid-state image pickup device 14. The image pickup optical system 13 receives light from an object and forms an object image. The solid-state image pickup device 14 picks up the object image that is formed by the image pickup optical system 13, and outputs an image signal obtained by an image pickup to the post-processing part 12. The camera module 11 is applied to, for example, electronic equipment such as a camera-equipped mobile terminal, other than the digital camera 1.

The post-processing part 12 includes an ISP (Image Signal Processor) 15, a storage part 16, and a display part 17. The ISP 15 executes signal processing for an image signal that is input from the solid-state image pickup device 14. The ISP 15 executes, for example, a high image quality process such as a noise elimination process, a defective pixel correction process, or a resolution conversion process.

The ISP 15 outputs an image signal after signal processing to the storage part 16, the display part 17, and a signal processing circuit 21 described later (see FIG. 2) that is included in the solid-state image pickup device 14 in the camera module 11. An image signal that is provided as feedback from the ISP 15 to the camera module 11 is used for adjustment or control of the solid-state image pickup device 14.

The storage part 16 stores, as an image, an image signal that is input from the ISP 15. The storage part 16 outputs an image signal for a stored image to the display part 17 depending on a user operation or the like. The display part 17 displays an image depending on an image signal that is input from the ISP 15 or the storage part 16. The display part 17 is, for example, a liquid crystal display.

Next, the solid-state image pickup device 14 that is included in the camera module 11 will be described with reference to FIG. 2. FIG. 2 is a block diagram illustrating a general configuration of the solid-state image pickup device 14 according to the embodiment. As illustrated in FIG. 2, the solid-state image pickup device 14 includes an image sensor 20, a signal processing circuit 21, and an FD switching part 29.

Herein, a case will be described where the image sensor 20 is a so-called front side illumination type CMOS (Complementary Metal Oxide Semiconductor) image sensor, where an interconnection layer is formed at a side of an incident-light incident face of a photoelectric conversion element that photoelectrically converts incident light. The image sensor 20 according to the present embodiment is not limited to the front side illumination type CMOS image sensor and may be a back side illumination type CMOS image sensor.

The image sensor 20 includes a peripheral circuit 22 that is mainly composed of an analog circuit, and a pixel array 23. The peripheral circuit 22 includes a vertical shift resistor 24, a timing control part 25, a CDS (correlated double sampling part) 26, an ADC (analog-digital conversion part) 27, and a line memory 28.

The pixel array 23 is provided in an image pickup region of the image sensor 20. In the pixel array 23, a plurality of photoelectric conversion elements that correspond to respective pixels of a picked up image are arrayed like a two-dimensional array (like a matrix) in a horizontal direction (row direction) and a vertical direction (column direction).

Each photoelectric conversion element is, for example, a photodiode that is formed by P-N junction of a P-type semiconductor layer that is of a first conductivity type and an N-type semiconductor region that is of a second conductivity type, and generates and stores a signal charge (for example, an electron) corresponding to an amount of incident light. The signal charge stored in the photoelectric conversion element is transferred to and retained in a floating diffusion in a case where a predetermined voltage is applied to a transfer gate that is provided for each photoelectric conversion element.

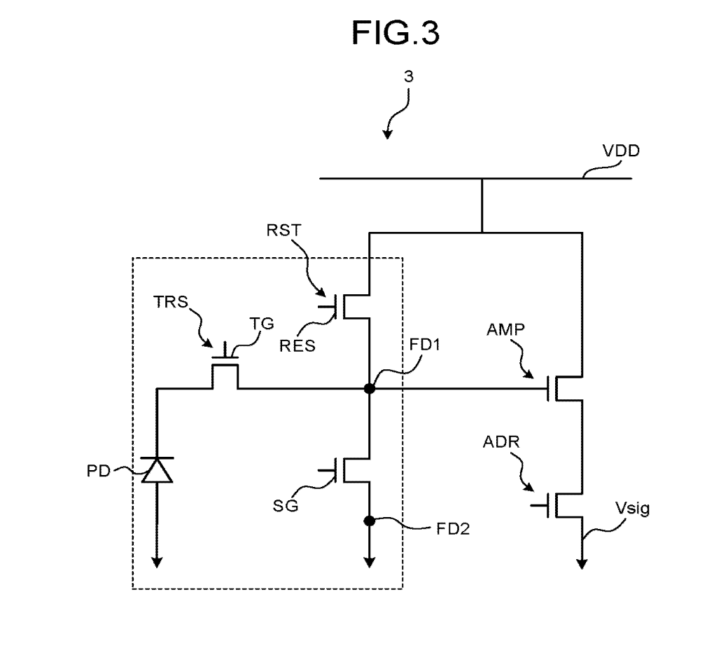

The pixel array 23 according to the embodiment causes the number of saturation electrons of such a floating diffusion to be variable and the FD switching part 29 increases or decreases the number of saturation electrons of the floating diffusion depending on a situation. A configuration or the like of such a floating diffusion will be described in detail, with reference to FIG. 3 and the subsequent drawings.

The FD switching part 29 decreases the number of saturation electrons of the floating diffusion in a case where an intensity of light incident on the pixel array 23 is less than a threshold, or increases the number of saturation electrons of the floating diffusion in a case where an intensity of light incident on the pixel array 23 is greater than or equal to the threshold.

For example, a voltage signal corresponding to the signal charge retained in the floating diffusion is input from the pixel array 23 to the FD switching part 29. The FD switching part 29 outputs, to the pixel array 23, a switching signal that decreases the number of saturation electrons of the floating diffusion, in a case where a voltage value of an input voltage signal is less than a threshold.

On the other hand, in a case where a voltage value of a voltage signal that is input from the pixel array 23 is greater than or equal to the threshold, the FD switching part 29 outputs, to the pixel array 23, a switching signal that increases the number of saturation electrons of the floating diffusion.

Thereby, in a case where an image to be picked up is comparatively dark and an intensity of incident light is less than a threshold, the solid-state image pickup device 14 decreases the number of saturation electrons of the floating diffusion, and thereby, can cause an S/N ratio (Signal to Noise ratio) to be good.

On the other hand, in a case where an image to be picked up is comparatively bright and an intensity of incident light is greater than or equal to the threshold, the solid-state image pickup device 14 increases the number of saturation electrons of the floating diffusion, and thereby, prevents the floating diffusion from reaching a saturation state. Thereby, it is possible for the solid-state image pickup device 14 to determine tone of incident light with high brightness appropriately.

The timing control part 25 is connected to the vertical shift resistor 24, the CDS 26, the ADC 27, and the line memory 28, and executes timing control of operations of the vertical shift resistor 24, the CDS 26, the ADC 27, and the line memory 28.

The vertical shift resistor 24 is a processing part that outputs, to the pixel array 23, a selection signal for sequentially selecting, line by line, photoelectric conversion elements to read signal charges therefrom, among a plurality of photoelectric conversion elements that are two-dimensionally arrayed like an array (matrix).

The pixel array 23 transfers the signal charge from each of the photoelectric conversion elements that are selected line by line depending on a selection signal that is input from the vertical shift resistor 24, to the floating diffusion, and outputs, to the CDS 26, a pixel signal that corresponds to the transferred signal charge and indicates brightness of each pixel.

The CDS 26 is a processing part that eliminates, by correlated double sampling, noise from, and outputs to the ADC 27, pixel signals that are input from the pixel array 23. The ADC 27 is a processing part that converts analog pixel signals that are input from the CDS 26 to, and outputs to the line memory 28, digital pixel signals. The line memory 28 is a processing part that temporarily retains, and outputs to the signal processing circuit 21 line by line of the photoelectric conversion elements of the pixel array 23, pixel signals that are input from the ADC 27.

The signal processing circuit 21 is a processing part that is mainly composed of a digital circuit, executes predetermined signal processing for pixel signals that are input from the line memory 28, and outputs pixel signals after signal processing to the post-processing part 12 as an image signal. The signal processing circuit 21 executes, for example, signal processing such as lens shading correction, flaw correction, or noise reduction processing, for the pixel signals.

The signal processing circuit 21 also executes a process for correcting pixel signals so that a rate of increase of a voltage value of a pixel signal associated with an increase of the number of signal charges is identical between a case where the number of saturation electrons of the floating diffusion in the pixel array 23 is increased and a case where the number of saturation electrons is decreased.

In a case where a rate of increase of a voltage value of a pixel signal associated with an increase of the number of signal charges is not changed even if the number of saturation electrons is increased or decreased, the signal processing circuit 21 does not have to have a function of executing correction processing for such pixel signals.

Thus, the image sensor 20 executes an image pickup in such a manner that the plurality of photoelectric conversion elements that are arrayed in the pixel array 23 photoelectrically convert incident light into, and store, an amount of signal charges that corresponds to an amount of received light, and the peripheral circuit 22 reads pixel signals corresponding to signal charges stored in respective photoelectric conversion elements.

Next, a configuration and an action of a circuit of the pixel array 23 will simply be described with reference to FIG. 3. FIG. 3 is a diagram illustrating an example of a circuit configuration of the pixel array 23 according to the embodiment. A circuit illustrated in FIG. 3 is a circuit that is a selectively extracted part of the pixel array 23 or a pixel cell 3 that corresponds to one pixel of a picked up image.

Although a case where one photoelectric conversion element PD that corresponds to one pixel of a picked up image is provided will be described herein, the number of photoelectric conversion elements PD provided so as to correspond to one pixel of a picked up image may be greater than or equal to 2.

As illustrated in FIG. 3, the pixel cell 3 includes a photoelectric conversion element PD, a transfer transistor TRS, a first floating diffusion FD1, a second floating diffusion FD2, a reset transistor RST, and a connection gate SG. The pixel cell 3 further includes an amplification transistor AMP and an address transistor ADR.

The photoelectric conversion element PD is a photodiode with a cathode that is connected to an overflow drain 30 through a well layer 33 described later (see FIG. 5) and an abode that is connected to a source of the transfer transistor TRS. A reference voltage, for example, a power-supply voltage is applied to the overflow drain 30.

The transfer transistor TRS is an FET (Field Effect Transistor) with a source that is an electric charge storage region of the photoelectric conversion element PD and a drain that is the first floating drain FD1. The transfer transistor TRS includes a transfer gate TG, and transfers the signal charge from the photoelectric conversion element PD to the first floating diffusion FD1 in a case where a voltage is applied to the transfer gate TG.

The first floating diffusion FD1 is a region that retains the signal charge that is transferred from the photoelectric conversion element PD, and is connected to a source of the reset transistor RST and a gate of the amplification transistor AMP.

The second floating diffusion FD2 is electrically separably connected to the first floating diffusion FD1 through the connection gate SG. The second floating diffusion FD2 is also connected to the overflow drain 30 through the well layer 33 described later (see FIG. 5). A reference voltage, for example, a power-supply voltage is applied to the overflow drain 30.

The second floating diffusion FD2 is disconnected from the first floating diffusion FD1 in a case where a switching signal at a Low level is input from the FD switching part 29 to the connection gate SG.

The second floating diffusion FD2 is connected to the first floating diffusion FD1 in a case where a switching signal at a High level is input from the FD switching part 29 to the connection gate SG.

The second floating diffusion FD2 cooperates with the first floating diffusion FD1 to retain the signal charge that is transferred from the photoelectric conversion element PD in a case where the second floating diffusion FD2 is connected to the first floating diffusion FD1.

The pixel cell 3 disconnects the first floating diffusion FD1 and the second floating diffusion FD2 from each other in a case where a picked up image is comparatively dark and an intensity of incident light is less than a threshold. Thereby, in the pixel cell 3, the first floating diffusion FD1 has a function of retaining a signal charge and the second floating diffusion FD2 does not execute retention of a signal charge.

Therefore, the pixel cell 3 decreases the number of retainable signal charges, that is, the number of saturation electrons as compared with a case where the first floating diffusion FD1 and the second floating diffusion FD2 are connected, and can cause an S/N ratio to be good.

On the other hand, the pixel cell 3 connects the first floating diffusion FD1 and the second floating diffusion FD2 in a case where a picked up image is comparatively light and an intensity of incident light is greater than or equal to the threshold. Thereby, in the pixel cell 3, both the first floating diffusion FD1 and the second floating diffusion FD2 cooperate to have a function of retaining a signal charge.

Therefore, the pixel cell 3 increases the number of retainable signal charges, that is, the number of saturation electrons as compared with a case where connection between the first floating diffusion FD1 and the second floating diffusion FD2 are disconnected from each other, and can determine tone of incident light with high brightness. The pixel cell 3 can discharge, to the overflow drain 30, the signal charge that is transferred to the second floating diffusion in excess of the number of saturation electrons.

The amplification transistor AMP is an FET with a gate that is connected to the first floating diffusion FD1, a source that is connected to a drain of the address transistor ADR, and a drain that is connected to a reference voltage line VDD. For example, a power-supply voltage as a reference voltage is applied to the reference voltage line VDD.

The address transistor ADR is an FET with a source that is connected to the CDS26 and a drain that is connected to a source of the amplification transistor AMP. The address transistor ADR is turned ON in a case where a selection signal is input from the vertical shift resistor 24 to a gate thereof.

In the pixel cell 3, the amplification transistor AMP outputs a pixel signal Vsig corresponding to a voltage of the signal charge that is applied to the transfer gate TG, through the address transistor ADR to the CDS 26, in a case where the address transistor ADR is turned ON.

The reset transistor RST is an FET with a source that is connected to the first floating diffusion FD1 and a drain that is connected to the reference voltage line VDD, and is turned ON in a case where a voltage is applied to a reset gate RES. The reset transistor RST is turned ON after a pixel signal Vsig is output from the address transistor ADR, and resets electric potentials of the first floating diffusion FD1 and the second floating diffusion FD2.

Specifically, the reset transistor RST is turned ON, as a voltage is applied to the reset gate RES on a condition that the first floating diffusion FD1 and the second floating diffusion FD2 are connected.

Thereby, the first floating diffusion FD1 and a drain of the reset transistor RST are connected, so that an electric potential of the first floating diffusion FD1 and an electric potential of the second floating diffusion FD2 are reset to a power-supply voltage.

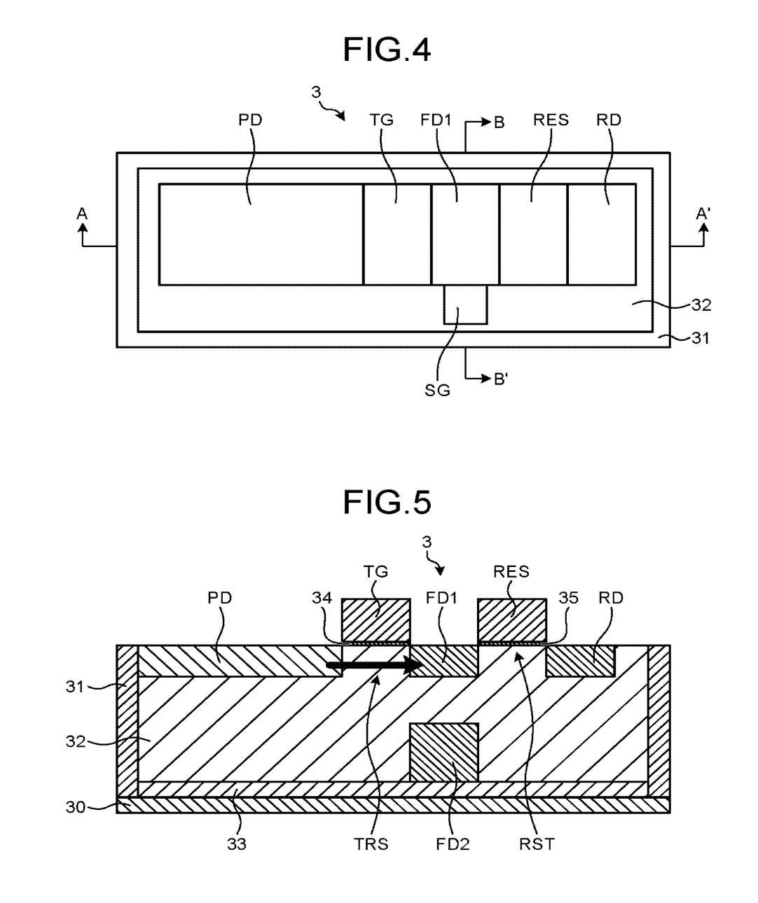

Next, a structure of the pixel cell 3 according to the embodiment will be described with reference to FIG. 4 to FIG. 6. Herein, structures of components surrounded by a dotted frame among components of the pixel cell 3 illustrated in FIG. 3 will be described.

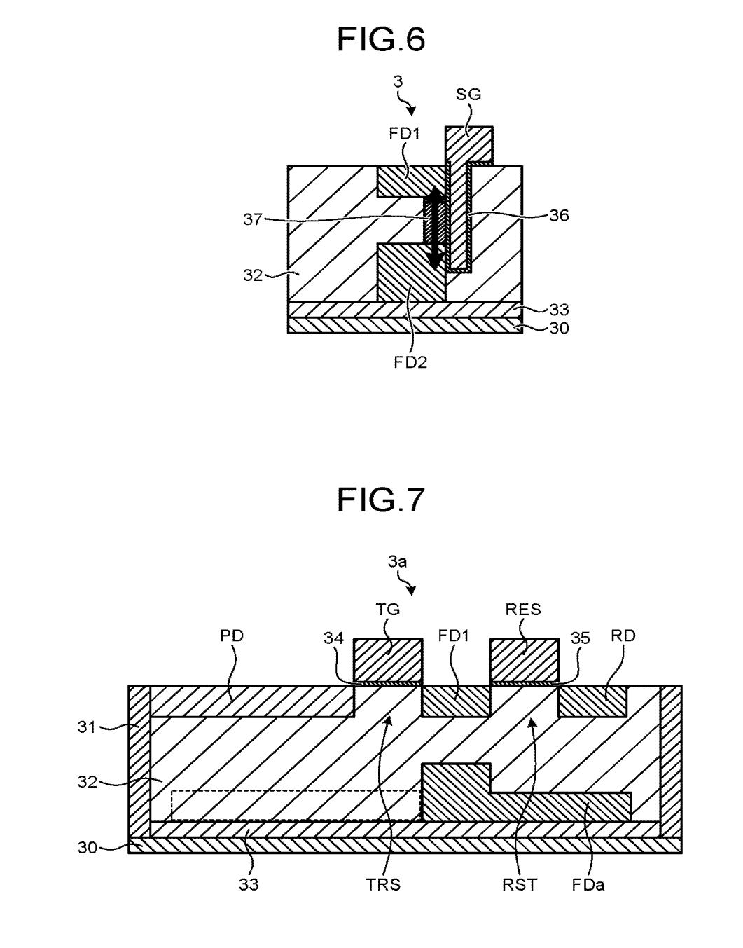

FIG. 4 is a diagram illustrating the pixel cell 3 according to the embodiment in a planar view. FIG. 5 is a cross-sectional diagram illustrating the pixel cell 3 according to the embodiment with respect to line A-A′ illustrated in FIG. 4. FIG. 6 is a cross-sectional diagram illustrating the pixel cell 3 according to the embodiment with respect to line B-B′ illustrated in FIG. 4.

FIG. 4 to FIG. 6 illustrate the pixel cell 3 on a condition that a multi-layer interconnection layer, a microlens, and a color filter are eliminated that are provided at a side of light receiving face in practice, so that arrangement of components that are included in the pixel cell 3 can be understood. Among respective components of the pixel cell 3 illustrated in FIG. 4 to FIG. 6, an identical component will be labeled with an identical reference numeral or letter.

As illustrated in FIG. 4, each pixel cell 3 includes an element separation region 31 that surrounds all four sides thereof, and a P-type semiconductor layer 32 that is provided in a region that is surrounded by the element separation region 31. The pixel cell 3 further includes a photoelectric conversion element PD, a transfer gate TG, a first floating diffusion FD1, a reset gate RES, and a reset drain RD that are arrayed in a line in a region surrounded by the element separation region 31.

The pixel 3 includes a connection gate SG that is provided adjacent to the first floating reason FD1. Herein, although not illustrated in FIG. 4, the pixel cell 3 includes the second floating diffusion FD2 at a position that is deeper than the first floating diffusion FD1 in the P-type semiconductor layer 32. A cross-sectional structure of the pixel cell 3 is illustrated in FIG. 5.

Specifically, as illustrated in FIG. 5, the pixel cell 3 includes an overflow drain 30 that composes a bottom face, a well layer 33 that is provided on the overflow drain 30, and a P-type semiconductor layer 32 that is provided on the well layer 33.

The overflow drain 30 is, for example, a semiconductor substrate such as a silicon substrate doped with an N-type impurity such as phosphorus. A reference voltage, for example, a power-supply voltage, is applied to the overflow drain 30.

The well layer 33 is, for example, a semiconductor film such as a silicon film doped with a P-type impurity such as boron. The P-type semiconductor layer 32 is, for example, an epitaxial layer of silicon doped with a P-type impurity such as boron.

The element separation region 31 is, for example, a DTI (Deep Trench Isolation) that is formed by embedding an insulating member such as silicon oxide in a trench that surrounds the well layer 33 and the P-type semiconductor layer 32 and reaches the overflow drain 30 from a surface of the P-type semiconductor layer 32.

The pixel cell 3 includes the second floating diffusion FD2 at a predetermined position on the well layer 33 in the P-type semiconductor layer 32. The pixel cell 3 includes the first floating diffusion FD1 at a position on a surface layer of the P-type semiconductor layer 32 where the first floating diffusion FD1 overlaps with the second floating diffusion FD2 in a planar view.

The floating diffusion FD1 and the second floating diffusion FD2 are, for example, N-type diffusion regions that are formed by ion-implanting an N-type impurity such as phosphorus into the P-type semiconductor layer 32 and executing an anneal process thereon.

Thus, the pixel cell 3 includes the floating diffusion FD1 on a surface layer of the P-type semiconductor layer 32. The pixel cell 3 includes the second floating diffusion FD2 at a position spaced apart from the first floating diffusion FD1 in a direction of a depth of the P-type semiconductor layer 32.

Thereby, the pixel cell 3 can ensure a region for the second floating diffusion FD2 without increasing an occupancy area. Therefore, the pixel cell 3 can increase a light-receiving area of the photoelectric conversion element PD as compared with, for example, a case where the first floating diffusion FD1 and the second floating diffusion FD2 are provided on a surface layer of the P-type semiconductor layer 32.

The pixel cell 3 includes the photoelectric conversion element PD at a position spaced apart from the first floating diffusion FD1 on a surface layer of the P-type semiconductor layer 32. The photoelectric conversion element PD is, for example, a photodiode that is formed by P-N junction between the P-type semiconductor layer 32 and an N-type diffusion region that is formed by ion-implanting an N-type impurity such as phosphorus into the P-type semiconductor layer 32 and executing an anneal process thereon.

The pixel cell 3 includes, for example, the transfer gate TG that is provided through a gate insulating film 34 such as a silicon oxide film on a surface of a region that is interposed between the first floating diffusion FD1 and the photoelectric conversion element PD in the P-type semiconductor layer 32. The transfer gate TG is formed of, for example, an electrically conductive member such as polysilicon.

The pixel cell 3 includes the reset drain RD that is provided separately from the first floating diffusion FD1 at an opposite side of the photoelectric conversion element PD while the first floating diffusion FD1 in a surface layer of the P-type semiconductor layer 32 is interposed therebetween. The reset drain RD is, for example, an N-type diffusion region that is formed by ion-implanting an N-type impurity such as phosphorus into the P-type semiconductor layer 32 and executing an anneal process thereon.

The pixel cell 3 includes the reset gate RES that is provided through, for example, a gate insulating film 35 such as a silicon oxide film, on a surface of a region that is interposed between the first floating diffusion FD1 and the reset drain RD in the P-type semiconductor layer 32. The reset gate RES is formed of, for example, an electrically conductive member such as polysilicon.

In the pixel cell 3, as a voltage is applied to the transfer gate TG, a channel is formed under the gate insulating film 34 just under the transfer gate TG. Thereby, the pixel cell 3 can transfer the signal charge from the photoconductive conversion element PD to the first floating diffusion FD1 as illustrated by a thick arrow in FIG. 5.

The pixel cell 3 includes the connection gate SG that extends in a direction of a depth of the P-type semiconductor layer 32 and is provided adjacent to the first floating diffusion FD1 and the second floating diffusion FD2 as illustrated in FIG. 6.

In a case where the connection gate SG is formed, for example, a trench is formed that reaches a side face of the second floating diffusion FD2 along a side face of the first floating diffusion FD1 from a surface of the P-type semiconductor layer 32.

An inner peripheral face of a trench and a surface of the P-type semiconductor layer 32 are coated with, for example, an insulating film 36 such as silicon oxide. Subsequently, the trench is embedded by an electrically conductive member such as polysilicon, and subsequently, an unwanted portion of the insulating film 36 and polysilicon are eliminated from the P-type semiconductor layer 32, so that the connection gate SG is formed.

The pixel cell 3 includes a channel diffusion region 37 with an N-type or P-type impurity being diffused along the connection gate SG, between the floating diffusion FD1 and the second floating diffusion FD2. The channel diffusion region 37 is formed by, for example, ion-implanting a P-type impurity such as boron or an N-type impurity such as phosphorus and executing an anneal process.

In a case of P-type, the channel diffusion region 37 can suppress contamination of the second floating diffusion FD2 with an electron that is irrelevant to incident light and causes dark current. On the other hand, in a case of an N-type, the channel diffusion region 37 can improve efficiency of transfer of a signal charge between the first floating diffusion FD1 and the second floating diffusion FD2.

The pixel cell 3 forms a channel in the channel diffusion region 37 as a voltage is applied to the connection gate SG. Thereby, in the pixel cell 3, the signal charge can freely travel back and forth between the first floating diffusion FD1 and the second floating diffusion FD2 as indicated by a bold double-headed arrow in FIG. 6. Therefore, the second floating diffusion FD2 can cooperate with the first floating diffusion FD1 to retain the signal charge.

As described above, a solid-state imaging device according to the embodiment includes a first floating diffusion that retains a signal current that is transferred from a photoelectric conversion element, and a second floating diffusion that is separably connected to the first floating diffusion. In a case where the second floating diffusion is electrically connected to the first floating diffusion, the second floating diffusion cooperates with the first floating diffusion to retain the signal charge.

Thereby, the solid-state imaging device disconnects the first floating diffusion and the second floating diffusion from each other, and thereby, can reduce the numbers of saturation electrons of the floating diffusions. On the other hand, the solid-state imaging device connects the first floating diffusion and the second floating diffusion, and thereby, can increase the numbers of saturation electrons of the floating diffusions.

Therefore, the solid-state imaging device decreases the numbers of saturation electrons of the floating diffusions in a case where an image to be picked up is comparatively dark, and thereby, can cause an S/N ratio to be good. The solid-state imaging device increases the numbers of saturation electrons of the floating diffusions in a case where an image to be picked up is comparatively light, and thereby, can determine tone of incident light with high brightness.

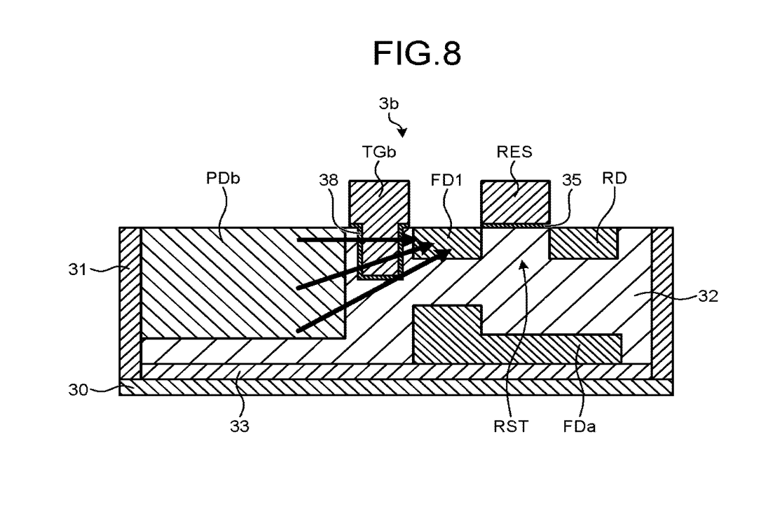

A structure of the pixel cell 3 illustrated in FIG. 5 and FIG. 6 is an example, and a variety of variations are allowed. Hereinafter, structures of the pixel cells 3a and 3b according to variation examples will be described with reference to FIG. 7 and FIG. 8. Arrangement and shapes of components of the pixel cells 3a and 3b according to the variation examples in a planar view are similar to those illustrated in FIG. 4, and a cross-sectional structure with respect to line A-A′ illustrated in FIG. 4 is different from that illustrated in FIG. 4.

Thus, cross-sectional structures of the pixel cell 3a and 3b according to the variation examples will be described herein. FIG. 7 is a cross-sectional diagram illustrating the pixel cell 3a according to variation example 1 of the embodiment and FIG. 8 is a cross-sectional diagram illustrating the pixel cell 3b according to variation example 2 of the embodiment.

As illustrated in FIG. 7, a shape of a second floating diffusion FDa in the pixel cell 3a according to variation example 1 is different from that of the second floating diffusion FD2 illustrated in FIG. 4.

Specifically, the second floating diffusion FDa extends from a position spaced apart from a first floating diffusion FD1 in a direction of a depth of a P-type semiconductor layer 32 to a region that overlaps with a reset gate RES and a reset drain RD in a planar view.

Thereby, a volume of the second floating diffusion FDa in the pixel cell 3a is greater than a volume of the first floating diffusion FD1, and thereby, the number of saturation electrons of the second floating diffusion FDa is further increased.

Therefore, because the pixel cell 3a can photoelectrically convert incident light with higher brightness into a signal charge and retain the signal charge in the second floating diffusion Fda, a dynamic range for receivable light can be extended.

The second floating diffusion FDa may have a shape that extends to a region indicated by a dotted line in the same drawing, that is, a region that overlaps with the photoelectric conversion element PD in a planar view. Thereby, in the pixel cell 3a, the number of saturation electrons of the second floating diffusion FDa is further increased, and hence, a dynamic range for receivable light can further be extended.

As illustrated in FIG. 8, a shape of a photoelectric conversion element PDb and a shape of a transfer gate TGb in the pixel cell 3b according to variation example 2 are different from those of the pixel cell 3a according to variation example 1. Specifically, the pixel cell 3b includes a photoelectric conversion element PDb that reaches a neighborhood of a well layer 33 from a surface layer of a P-type semiconductor layer 32.

The pixel cell 3b further includes a transfer gate TGb that extends from a surface of the P-type semiconductor layer 32 in a direction of a depth of the P-type semiconductor layer 32, between the photoelectric conversion element PDb and a first floating diffusion FD1. For example, an insulting film 38 such as a silicon oxide film is provided on an interface between the transfer gate TGb and the P-type semiconductor layer 32.

According to the pixel cell 3b, a region of the photoelectric conversion element PDb can be extended to a deep position of the P-type semiconductor layer 32, and hence, a received-light sensitivity of the photoelectric conversion element PDb can be improved.

The pixel cell 3b includes the transfer gate TGb with a trench gate structure, and hence, can transfer a signal charge from a surface layer portion, a middle layer portion, and a deep layer portion of the photoelectric conversion element PDb to the first floating diffusion FD1 as indicated by a bold arrow in FIG. 8. It is possible to form the transfer gate TGb simultaneously in a process for forming the connection gate SG. For this reason, it is not necessary to add a new manufacturing process in order to form the transfer gate TGb.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state image pickup device, comprising:
a photoelectric conversion element that photoelectrically converts incident light into signal charge;
a first floating diffusion that retains the signal charge that is transferred from the photoelectric conversion element; and
a second floating diffusion that is electrically connectable to or separable from the first floating diffusion and is capable of retaining the signal charge.

2. The solid-state image pickup device as claimed in claim 1, further comprising:
a connection gate that is provided from a surface of a semiconductor layer in a depth direction thereof, the photoelectric conversion element being provided on the surface of the semiconductor layer, wherein
the first floating diffusion is provided adjacent to the connection gate and on a surface layer of the semiconductor layer, and
the second floating diffusion is provided adjacent to the connection gate and at a position spaced apart from the first floating diffusion in the depth direction in the semiconductor layer.

3. The solid-state image pickup device as claimed in claim 2, wherein
a volume of the second floating diffusion is greater than that of the first floating diffusion.

4. The solid-state image pickup device as claimed in claim 3, further comprising:
a well layer that is provided on a surface of the second floating diffusion and has a conductivity type opposite to that of the second floating diffusion, the surface of the second floating diffusion being a side opposite to a side facing the first floating diffusion; and
an overflow drain that is provided on a surface of the well layer and has a same conductivity type as that of the second floating diffusion, the surface of the well layer being a side opposite to a side facing the second floating diffusion.

5. The solid-state image pickup device as claimed in claim 1, further comprising:
a switching part that disconnects the first floating diffusion and the second floating diffusion from each other in a case where an intensity of light incident on the photoelectric conversion element is less than a threshold, and that connects the first floating diffusion and the second floating diffusion to each other in a case where the intensity of light is greater than or equal to the threshold.

6. The solid-state image pickup device as claimed in claim 4, wherein
the second floating diffusion discharges, to the overflow drain, signal charge that is transferred in excess of a number of saturation electrons.

7. The solid-state image pickup device as claimed in claim 1, further comprising
a reset transistor with a source that is connected to the first floating diffusion and a drain that is connected to a predetermined reference voltage line, wherein
the reset transistor is turned ON in a state where the first floating diffusion and the second floating diffusion are connected.

8. The solid-state image pickup device as claimed in claim 2, wherein
the photoelectric conversion element, a gate of a transfer transistor that transfers the signal charge from the photoelectric conversion element to the first floating diffusion, the first floating diffusion, a gate of the reset transistor that resets the signal charge stored in the first floating diffusion, and the drain of the reset transistor are arrayed in a line in a planar view, and
the connection gate is provided adjacent to a side face other than a side face adjacent to the gate of the transfer transistor and a side face adjacent to the gate of the reset transistor, among side faces of the first floating diffusion.

9. The solid-state image pickup device as claimed in claim 1, wherein
the first floating diffusion is provided at a position where the first floating diffusion overlaps with the second floating diffusion in a planar view.

10. The solid-state image pickup device as claimed in claim 1, further comprising
a channel diffusion region with an N-type impurity diffused along the connection gate, between the first floating diffusion and the second floating diffusion.

11. The solid-state image pickup device as claimed in claim 1, comprising
a channel diffusion region with a P-type impurity diffused along the connection gate, between the first floating diffusion and the second floating diffusion.

12. The solid-state image pickup device as claimed in claim 8, wherein
the second floating diffusion is provided from a position spaced apart from the first floating diffusion in the depth direction of the semiconductor layer to a position where the second floating diffusion overlaps with the gate of the reset transistor in a planar view.

13. The solid-state image pickup device as claimed in claim 8, wherein
the second floating diffusion is provided from a position spaced apart from the first floating diffusion in the depth direction of the semiconductor layer to a position where the second floating diffusion overlaps with the drain of the reset transistor in a planar view.

14. The solid-state image pickup device as claimed in claim 8, wherein
the second floating diffusion is provided from a position spaced apart from the first floating diffusion in the depth direction of the semiconductor layer to a position where the second floating diffusion overlaps with the photoelectric conversion element in a planar view.

15. The solid-state image pickup device as claimed in claim 8, wherein
the photoelectric conversion element reaches from a surface layer of the semiconductor layer to a neighborhood of the well layer, and
the gate of the transfer transistor is provided in the depth direction of the semiconductor layer from the surface layer of the semiconductor layer.
